(19) United States
(12) Patent Application Publication
(10) Pub. No.: US 2005/0206387 A1
(43) Pub. Date: Sep. 22, 2005

(54) Device for measuring an electrical quantity of a storage battery

(75) Inventor: Armin Hirthammer, Regensburg (DE)

Correspondence Address: LERNER AND GREENBERG, PA, P O BOX 2480, HOLLYWOOD, FL, 33022-2480, US

(73) Assignee: Siemens Aktiengesellschaft

(21) Appl. No.: 11/085,719

(22) Filed: Mar. 21, 2005

(30) Foreign Application Priority Data
Mar. 19, 2004 (DE) 10 2004 013 659.9

(51) Int. Cl. G01N 27/416

(52) U.S. Cl. 324/426

(57) ABSTRACT

A device for measuring an electrical quantity of a storage battery has a measuring element disposed in a housing. The measuring element is connected in series with a storage battery. The contact elements which are led through the housing are sealed off by way of sealing elements.

### BACKGROUND OF THE INVENTION

Field of the Invention

The invention relates to a device for measuring an electrical quantity of a storage battery, in particular a storage battery of a motor vehicle.

Due to the rapidly increasing number of electrical loads, monitoring devices are provided more and more frequently in order to measure the state of charge and state of health of the storage battery itself. The monitoring devices allow conclusions to be drawn about the state of the storage battery on the basis of the voltage dropping across the storage battery or the charge and discharge current of the storage battery.

A prior art pole terminal—as it is described in German published patent application DE 35 32 044 A1 and its counterpart U.S. Pat. No. 4,675,255—has a Hall element and evaluation electronics. The Hall voltage dropping across the Hall element is proportional to a magnetic induction. In this way it is possible to deduce the cause of the induction, the current flowing through the body of the pole terminal.

With a known subject matter of that kind it proves to be problematical to ensure the proper operation of the evaluation electronics also under adverse ambient conditions. A typical case of an application for such a measuring device is for example the monitoring of a storage battery in a motor vehicle. In such an application it must be ensured for example that the evaluation electronics is also protected against dust and water.

### SUMMARY OF THE INVENTION

It is accordingly an object of the invention to provide a device for detecting an electrical quantity of a battery which overcomes the above-mentioned disadvantages of the heretofore-known devices and methods of this general type and which retains its operational integrity even under adverse ambient conditions.

With the foregoing and other objects in view there is provided, in accordance with the invention, a device for measuring an electrical quantity of a storage battery, comprising:
a measuring element disposed in a housing and having a first connection and a second connection;
a first contact element electrically connected to the first connection of the measuring element; and
a second contact element electrically connected to the second connection of the measuring element;
the housing having a recess formed therein for allowing at least one of the first and second contact elements to be guided therethrough; and
a sealing element disposed between the housing and the at least one contact element.

In other words, the device has a housing and a measuring element which is disposed in the interior of the housing and has a first and second connection. In addition the device has a first and a second contact element which are led through the housing from the outside and are electrically connected to the first and second connection. In this configuration at least one contact element is sealed off by means of a sealing element in the area where it is led through the housing.

In accordance with an added feature of the invention, the sealing element is preferably implemented as a radially arranged sealing element joined to the housing to form a single piece.

In accordance with a further embodiment, the sealing element is a gasket disposed between the contact element and the housing.

In accordance with a preferred feature of the invention, the first contact element is a pole terminal that is connected both electrically and mechanically to a pole of a storage battery.

The device disclosed here thus has the advantage, among other things, that the sealing element in the area where the contact elements are led through the housing protects the interior of the housing and hence the electronics disposed therein against the infiltration of foreign matter such as moisture or dust.

Other features which are considered as characteristic for the invention are set forth in the appended claims.

Although the invention is illustrated and described herein as embodied in a device for measuring an electrical quantity of a storage battery, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a section taken through a device according to the invention for measuring an electrical quantity of a storage battery;

FIG. 2 is an enlarged view of the detail II in FIG. 1 in which an exemplary embodiment of a sealing element according to the invention is depicted; and

FIG. 3 is a block diagram illustrating the device of FIG. 1 integrated in an electrical system with a storage battery.

### DESCRIPTION OF THE PREFERRED EMBODIMENTS

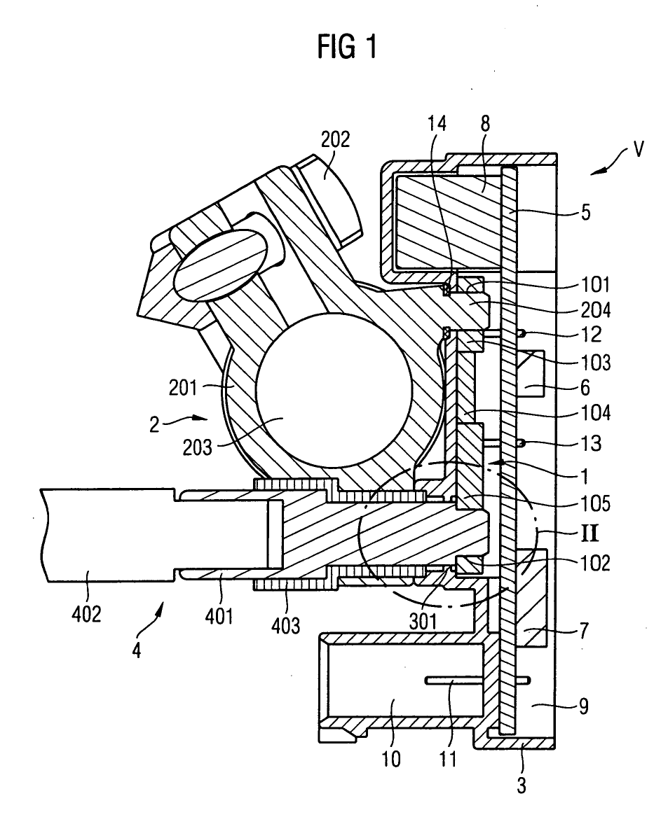

Referring now to the figures of the drawing in detail and first, particularly, to FIG. 1 thereof, there is shown a sectional image of a device V. The device has a housing 3 in which a measuring element 1 is disposed. The measuring element has a first side 103 and a second side 105 between which a precision measuring resistor 104 is disposed. The measuring resistor 104 is made for example of manganin (Cu, Mn, Ni). The first and second sides 103, 105 of the measuring element 1 are formed of copper.

In order to lead the current that is to be measured through the measuring element 1, the measuring element 1 also has a first connection 101 and a second connection 102. A contact element 204 of a pole terminal 2 is electrically connected to the first connection 101. Said pole terminal 2 has a clamping ring 201, a clamping screw 202 and, in the clamping ring 201, a recess 203 for accommodating a pole body P (cf. FIG. 3).

The pole terminal 2 can be electrically and mechanically connected to a pole P of a storage battery B, in this case preferably to the negative pole P−. A secure connection is ensured here by tightening the clamping ring 201. This is achieved by tightening the clamping screw 202.

The second connection 102 of the measuring element 1 is electrically connected to a second contact element 4 that is led through the housing. Said second contact element has a connecting piece 401 and a cable 402, in this case a ground cable, which is molded, soldered and/or welded to said connecting piece.

The connection between the contact elements 2, 4 and the measuring element 1 can be welded, soldered and/or molded.

In order now to ensure that the entire current flow is directed via the measuring element 1 and no leakage current flows directly from the pole terminal 2 to the second contact element 4, an insulating sleeve 403 made of plastic is disposed between the pole terminal 2 and the connecting piece 401. Said insulating sleeve 403 also fulfills a further purpose in that it stabilizes the second contact element 4 with regard to vibrations.

In order to ensure a tightly sealed passage through the housing 2 in the area of the second contact element 4, the housing 3 has a radial sealing element 301 which is implemented in this case as a single piece with the housing. During assembly the connecting piece 401 is forced into the housing 3 and then connected to the measuring element 1. After the mating the sealing element 301 encloses the connecting piece 401, thereby ensuring a tightly sealed passage through the housing 3.

In order to seal off the passage through the housing 3, a further sealing element 14, in this case an O-ring, is inserted between contact element 204 and housing 3 in the area of the first contact element 204, in this case the pole terminal 2. By this means a tightly sealed passage through the housing 3 is achieved at that point also.

In order to measure and evaluate the current flow through the measuring element 1, the voltage dropping across the precision resistor 104 is measured. For this purpose the device has a first contact pin 12 and a second contact pin 13. These are disposed in the area of the first and second side 103, 105 respectively and connect each of said sides 103, 104 to a connection zone of evaluation electronics circuitry disposed on a printed circuit board 5. In this case the evaluation electronics has a microprocessor 6 and an application-specific integrated circuit (ASIC) 7. The evaluation electronics serves to determine the state of the storage battery (SOH—State Of Health) and its state of charge (SOC—State Of Charge) from the current flow through the measuring element 1 and if necessary from further parameters such as, for example, a voltage dropping across the storage battery, the storage battery temperature or operating data of the internal combustion engine.

In order to ensure the operation of the evaluation electronics 6, 7 also in the event of voltage fluctuations or in addition in the case of a storage battery replacement, the electronics has an emergency energy store 8, for example a capacitor. The latter is likewise disposed in the housing 3.

In order to transfer the data SOC, SOH thus determined to a further electrical device, for example an onboard computer or a controller of the motor vehicle, the device has an interface with a connecting socket 10 and at least one contact pin 11 for a data cable D. Not visible here on account of the section is a further contact pin 11 which connects the circuit configuration disposed in the housing 3 to the positive pole of the storage battery B. This connection serves to supply voltage to the circuit configuration. Electrical contact with said contact pins 11 is established by means of a watertight plug-in connector (not shown in the figure).

In order to close off the side of the housing 3 that faces away from the pole terminal 2 and the second connecting element 4 with a watertight seal, the housing is sealed here by means of a potting compound 9, for example polyurethane.

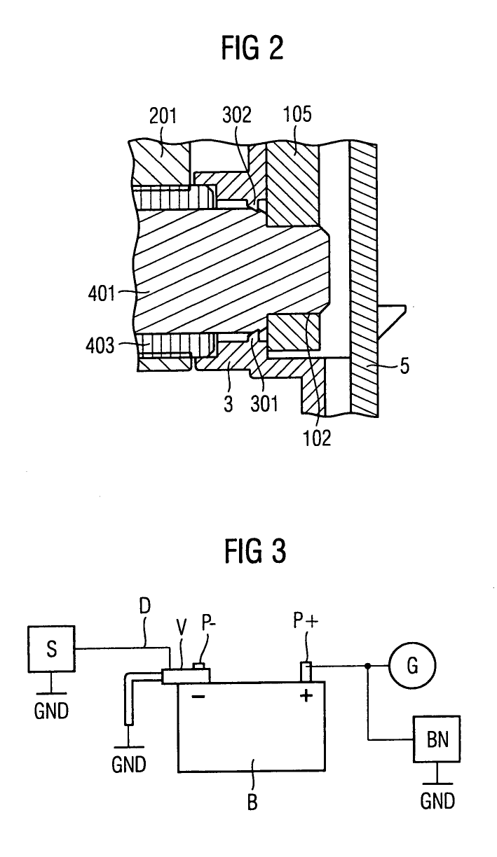

FIG. 2 shows the area II of FIG. 1 in magnified form. In order to enable easy mating of the respective contact element 2, 4 and the housing 3, the sealing element 301 has a bevel 302 directed toward the exterior of the housing.

The diameter of the housing recess for the contact element 401 is smaller in the area of the sealing element 301 than the diameter of the contact element 401.

FIG. 3 shows a schematic representation of the device V for measuring the state of a storage battery SOC, SOH, as already illustrated in FIG. 1. In this case the device is electrically connected to the negative pole P− of a storage battery B. The positive pole P+ of the storage battery B is connected on the one hand to a generator G and on the other hand to a vehicle electrical system BN having an electrical load. The device V having the measuring element 1 is connected in series between the ground connection GND of the vehicle electrical system BN and the storage battery B. A data cable D connects the contact pin 11 of the device V to a control device S and supplies the latter with data allowing the state of the storage battery B to be deduced.

This application claims the priority, under 35 U.S.C. § 119, of German patent application No. 10 2004 013 659.9, filed Mar. 19, 2004; the entire disclosure of the prior application is herewith incorporated by reference.

1. A device for measuring an electrical quantity of a storage battery, comprising:
a housing;
a measuring element disposed in said housing and having a first connection and a second connection;
a first contact element electrically connected to said first connection; and
a second contact element electrically connected to said second connection;
said housing having a recess formed therein for allowing at least one of said first and second contact elements to be guided therethrough; and
a sealing element disposed between said housing and said at least one contact element.

2. The device according to claim 1, wherein said sealing element is integrally formed in a single piece with said housing.

3. The device according to claim 2, wherein said sealing element is formed with a bevel facing toward an exterior of said housing.

4. The device according to claim 1, which comprises evaluation electronics disposed in an interior of said housing, and a quantity of potting compound for sealing said evaluation electronics.

5. The device according to claim 1, wherein said first contact element is joined to form a single piece with a pole terminal, and said pole terminal has a recess through which said second contact element is connected to said second connection of said measuring element.

6. The device according to claim 5, which comprises an insulating sleeve disposed between said pole terminal and said second contact element.
